(19) United States
(12) Patent Application Publication
(10) Pub. No.: US 2024/0404418 A1
(43) Pub. Date: Dec. 5, 2024

(54) VR-BASED STANDARDIZED TRAINING SYSTEM FOR MULTI-PERSON ONLINE COOPERATED FIRST-AID NURSING OF TRAUMA

(71) Applicant: Tongji Hospital affiliated to Tongji Medical College of Huazhong University of Science & Technology, Wuhan (CN)

(72) Inventors: Jing CHENG, Wuhan (CN); Huibing CHEN, Wuhan (CN); La XIE, Wuhan (CN); Yaru XIAO, Wuhan (CN); Xiangping LIU, Wuhan (CN); Jie WU, Wuhan (CN); Zheying LI, Wuhan (CN); Hui WU, Wuhan (CN); Jingjing FU, Wuhan (CN)

(73) Assignee: Tongji Hospital affiliated to Tongji Medical College of Huazhong University of Science & Technology, Wuhan (CN)

(21) Appl. No.: 18/648,251

(22) Filed: Apr. 26, 2024

(30) Foreign Application Priority Data
May 29, 2023 (CN) 2023106413539

(51) Int. Cl. G09B 5/06

(52) U.S. Cl. CPC G09B 5/065

(57) ABSTRACT

The present application provides a VR-based standardized training system for multi-person online cooperated first-aid nursing of trauma, which is used for providing medical staff with an efficient and convenient-to-update and maintain standardized training environment for multi-person online cooperated first-aid nursing of trauma by introducing the VR technology, so as to significantly improve the training effect of the first aid of trauma of the medical staff. The system includes: a teacher-side processing device, which is used for performing task configuration processing on a standardized training task for multi-person online cooperated first-aid nursing of trauma; a management-side server device, which is used for configuring a VR environment of the standardized training task for multi-person online cooperated first-aid nursing of trauma for a trainee-side VR device according to the configuration content of the task configuration processing performed by the teacher-side processing device; and the trainee-side VR device.

### CROSS-REFERENCE TO RELATED APPLICATIONS

The present application claims priority to Chinese patent application No. 2023106413539, filed on May 29, 2023, the entire contents of which are incorporated herein by reference.

### TECHNICAL FIELD

The present application relates to the field of hospital-based training, in particular to a virtual reality (VR)-based standardized training system for multi-person online cooperative trauma emergency nursing.

### BACKGROUND

A training for trauma emergency is involved in the hospital work. By virtue of usually organized trainings for trauma emergency, medical staff can practice and keep familiar with emergency treatment for patients with trauma, so as to ensure that their performance in real emergency treatments of trauma can be excellent. As a result, the training for trauma emergency is of great significance.

Moreover, it is found by the inventor of the present application that current training tasks for trauma emergency in the hospitals mainly depend on offline trainings with entity models of human bodies and assessment by the departments. However, this requires the assignment of many people, which is often difficult to unify and coordinate, mainly featured in the following aspects: 1, computer-based operation is mainly adopted, which leads to lower sense of engagement and easiness of distraction; 2, teamwork is difficult to realize, and single-person operation is often used, leading to a lack of teamwork awareness; 3, the process of training cases is inflexible, relies greatly on the development of new case scenarios, and cannot be flexibly expanded and changed; 4, the training content is not complete and cannot meet the requirements of all positions; and 5, the offline trainings require a lot of early-stage preparations for devices, staff, time and sites, which is not flexible enough.

In other words, with regard to the medical staff participating in the training, existing hospitals have the disadvantage of limited treatment effect because of carrying out the training task for trauma emergency by virtue of computer-based operation and offline actual operation.

### SUMMARY

The present application provides a virtual reality (VR)-based standardized training system for multi-person online cooperative trauma emergency nursing, which is used for providing medical staff with an efficient and conveniently-updated and maintained standardized training environment for multi-person online cooperative trauma emergency nursing by introducing a VR technology, so as to significantly improve the training effect of trauma emergency nursing of the medical staff.

In a first aspect, the present application provides a VR-based standardized training system for multi-person online cooperative trauma emergency nursing, where the system includes:
a teacher-side processing device, which is used for performing task configuration processing on a standardized training task for multi-person online cooperative trauma emergency nursing, where configuration content of the task configuration processing includes: creating a training, configuring trainers and a training program, pairing devices, checking a training progress, providing a view from a trainer perspective, and controlling the training;
a management-side server device, which is used for configuring a VR environment of the standardized training task for multi-person online cooperative trauma emergency nursing for student-side VR devices according to the configuration content of the task configuration processing performed by the teacher-side processing device; and
the student-side VR devices, which are used for downloading VR resources from the management-side server device according to the configuration content of the task configuration processing, and starting a standardized training for multi-person online cooperative trauma emergency nursing after a scenario is initialized and a training scenario is introduced, where the VR resources include scenarios, props, roles and tasks.

With reference to the first aspect of the present application, in a first possible implementation of the first aspect of the present application, a plurality of student-side VR devices constitute a small local area network environment through an ad hoc network, and carry out data synchronization and transmission in the VR environment to realize real-time network synchronization of multi-person operation.

With reference to the first possible implementation of the first aspect of the present application, in a second possible implementation of the first aspect of the present application, at least one of state synchronization, real-time broadcast synchronization and frame synchronization is specifically employed as the network synchronization, and the network synchronization aims at simulating behaviors of other students with less amount of information synchronized.

With reference to the second possible implementation of the first aspect of the present application, in a third possible implementation of the first aspect of the present application, the state synchronization includes the following processing content:
when a current user gives a behavior control instruction through the student-side VR device, extracting data required by a behavior state in the behavior control instruction; and
broadcasting the data required by the behavior state to other student-side VR devices to facilitate simulation of behaviors of a corresponding role through the data required by the behavior state.

With reference to the first possible implementation of the first aspect of the present application, in a fourth possible implementation of the first aspect of the present application, the real-time broadcast synchronization includes the following processing content:
sending, by a student-side VR device in use, position and rotation information of a student role to other student-side VR devices in a form of broadcasting; predicting, by the other student-side VR devices, current position, speed and acceleration of the student role of the student-side VR device in use according to received position and rotation information, and then predicting, by the other student-side VR devices, a rotation speed and a rotational acceleration to simulate the student role of the student-side VR device in use.

With reference to the first aspect of the present application, in a fifth possible implementation of the first aspect of the present application, spatial localization of a corresponding role of the student-side VR device in a VR environment employs an inside-out localization technology, a surrounding environment is actively scanned through a plurality of cameras on the device, and a simultaneous localization and mapping (SLAM) technology is used for locating the role while creating a map.

With reference to the first aspect of the present application, in a sixth possible implementation of the first aspect of the present application, the management-side server device completes a multi-person task through automatic hosting of an artificial intelligence (AI) service in a case that any trainer is offline or does not participate in the training during the task;

the management-side server device enables multiple trainers to keep own task lines by utilizing a multi-thread and multi-task-line technology, where a degree of freedom of an individual task is higher than that of the multi-person task;

the management-side server device utilizes a structured database to construct a drug library, an instrument library, a consumable library, a report library, a patient library, a scenario library, a student library, a device library, a traumatic condition library and a treatment library, and randomly collocates different cases in a background management system to automatically form a massive case library system; and
the management-side server device utilizes a hot update technology to facilitate dynamic on-demand loading of scripts, models and resources.

With reference to the first aspect of the present application, in a seventh possible implementation of the first aspect of the present application, the student-side VR device realizes voice conversation among roles by using a text to speech (TTS) system.

In a second aspect, the present application provides a processing method of a VR-based standardized training system for multi-person online cooperative trauma emergency nursing, where the method includes:
performing, by a teacher-side processing device, task configuration processing on a standardized training task for multi-person online cooperative trauma emergency nursing, where configuration content of the task configuration processing includes: creating a training, configuring trainers and a training program, pairing devices, checking a training progress, providing a view from a trainer perspective, and controlling the training;
configuring, by a management-side server device, a VR environment of the standardized training task for multi-person online cooperative trauma emergency nursing for student-side VR devices according to the configuration content of the task configuration processing performed by the teacher-side processing device; and
downloading, by the student-side VR devices, VR resources from the management-side server device according to the configuration content of the task configuration processing, and starting a standardized training for multi-person online cooperative trauma emergency nursing after a scenario is initialized and a training scenario is introduced, where the VR resources include scenarios, props, roles and tasks.

With reference to the second aspect of the present application, in a first possible implementation of the second aspect of the present application, a plurality of student-side VR devices constitute a small local area network environment through an ad hoc network, and carry out data synchronization and transmission in the VR environment to realize real-time network synchronization of multi-person operation.

With reference to the first possible implementation of the second aspect of the present application, in a second possible implementation of the second aspect of the present application, at least one of state synchronization, real-time broadcast synchronization and frame synchronization is specifically employed as the network synchronization, and the network synchronization aims at simulating behaviors of other students with less amount of information synchronized.

With reference to the second possible implementation of the second aspect of the present application, in a third possible implementation of the second aspect of the present application, the state synchronization includes the following processing content:
when a current user gives a behavior control instruction through the student-side VR device, extracting data required by a behavior state in the behavior control instruction; and
broadcasting the data required by the behavior state to other student-side VR devices to facilitate simulation of behaviors of a corresponding role through the data required by the behavior state.

With reference to the first possible implementation of the second aspect of the present application, in a fourth possible implementation of the second aspect of the present application, the real-time broadcast synchronization includes the following processing content:
sending, by a student-side VR device in use, position and rotation information of a student role to other student-side VR devices in a form of broadcasting; predicting, by the other student-side VR devices, current position, speed and acceleration of the student role of the student-side VR device in use according to received position and rotation information, and then predicting, by the other student-side VR devices, a rotation speed and a rotational acceleration to simulate the student role of the student-side VR device in use.

With reference to the second aspect of the present application, in a fifth possible implementation of the second aspect of the present application, spatial localization of a corresponding role of the student-side VR device in a VR environment employs an inside-out localization technology, a surrounding environment is actively scanned through a plurality of cameras on the device, and an SLAM technology is used for locating the role while creating a map.

With reference to the second aspect of the present application, in a sixth possible implementation of the second aspect of the present application, the management-side server device completes a multi-person task through automatic hosting of an AI service in a case that any trainer is offline or does not participate in the training during the task;
the management-side server device enables multiple trainers to keep own task lines by utilizing a multi-thread and multi-task-line technology, where a degree of freedom of an individual task is higher than that of the multi-person task;
the management-side server device utilizes a structured database to construct a drug library, an instrument library, a consumable library, a report library, a patient library, a scenario library, a student library, a device library, a traumatic condition library and a treatment library, and randomly collocates different cases in a background management system to automatically form a massive case library system; and
the management-side server device utilizes a hot update technology to facilitate dynamic on-demand loading of scripts, models and resources.

With reference to the second aspect of the present application, in a seventh possible implementation of the second aspect of the present application, the student-side VR device realizes voice conversation among roles by using a TTS system.

In a third aspect, the present application provides a computer-readable storage medium with a plurality of instructions stored, where the instructions are suitable for being loaded by a processor to execute the method provided by the second aspect of the present application or any possible implementation of the second aspect of the present application.

It can be seen from the above content that the present application has the following beneficial effects:
for the training for trauma emergency, the present application introduces the VR technology to establish the VR-based standardized training system for multi-person online cooperative trauma emergency nursing; the teacher-side processing device performs the task configuration processing on the standardized training task for multi-person online cooperative trauma emergency nursing, the management-side server device configures the VR environment of the standardized training task for multi-person online cooperative trauma emergency nursing for the student-side VR devices according to the configuration content of the task configuration processing performed by the teacher-side processing device; the student-side VR devices download the VR resources from the management-side server device according to the configuration content of the task configuration processing, and start the standardized training for multi-person online cooperative trauma emergency nursing after the scenario is initialized and a training scenario is introduced; in this system architecture, the device of each side is configured based on the VR technology to form a complete application scenario, so as to provide the medical staff with an efficient and conveniently-updated and maintained standardized training environment for multi-person online cooperative trauma emergency nursing, which can significantly improve the training effect of trauma emergency nursing of the medical staff.

### BRIEF DESCRIPTION OF THE DRAWINGS

To describe the technical solutions in the embodiments of the present application more clearly, the accompanying drawings required to describe the embodiments are briefly described below. Apparently, the accompanying drawings described below are only some embodiments of the present application. Those skilled in the art may further obtain other accompanying drawings based on these accompanying drawings without creative efforts.

FIG. 1 is a schematic architecture diagram of a VR-based standardized training system for multi-person online cooperative trauma emergency nursing of the present application; and

FIG. 2 is an example schematic diagram of a VR-based standardized training system for multi-person online cooperative trauma emergency nursing of the present application.

### DETAILED DESCRIPTION OF THE EMBODIMENTS

The technical solutions in the embodiments of the present application are clearly and completely described below with reference to the accompanying drawings in the embodiments of the present application. Apparently, the described embodiments are merely some rather than all of the embodiments of the present application. All other embodiments obtained by those skilled in the art based on the embodiments of the present application without creative efforts shall fall within the protection scope of the present application.

The terms “first”, “second”, and so on in the description and claims of the present application and in the above accompanying drawings are intended to distinguish between similar objects but do not necessarily indicate a specific order or sequence. It should be understood that data used in such a way may be exchanged under proper conditions to make it possible to implement the embodiments described here in other sequences apart from those illustrated or described here. Moreover, the terms “include”, “comprise”, and any other variants mean to cover the non-exclusive inclusion, for example, a process, method, system, product, or device that includes a list of steps or modules is not necessarily limited to those steps or modules which are clearly listed, but may include other steps or units which are not expressly listed or inherent to such a process, method, system, product, or device. The names or numbers of steps in the present application do not mean that the steps in the method flow must be executed in a time/logical sequence indicated by the names or numbers, and the execution order of the named or numbered process steps can be changed according to the technical purpose to be achieved, as long as the same or similar technical effects can be achieved.

The division of modules appearing in the present application is based on logic, and there may be other division methods when the division is realized in actual application. For example, a plurality of modules can be incorporated or integrated into another system, or some features can be ignored or are not executed; furthermore, the mutual coupling or direct coupling or communication connection shown or discussed can be realized through certain interfaces, and the indirect coupling or communication connection between the modules can be electrical or other similar forms, which are not limited in the present application. Also, the modules or submodules mentioned above as separate components can be, or may not be physically separated, or may not be physical modules, or can be distributed across a plurality of circuit modules; and some or all of the modules can be selected according to actual needs to achieve the purpose of the solution of the present application.

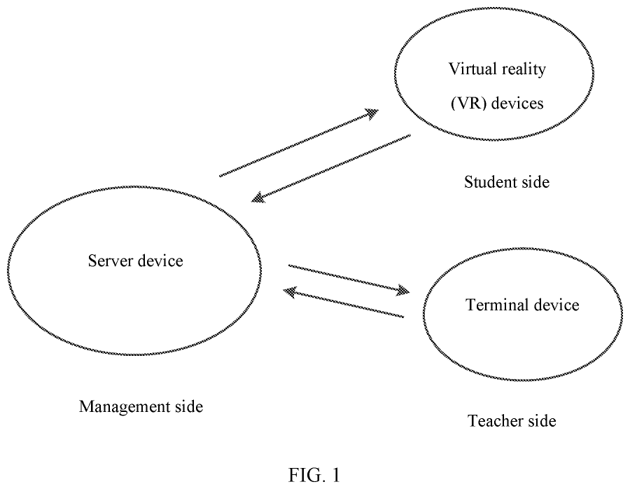

First of all, referring to FIG. 1, FIG. 1 shows a schematic architecture diagram of a VR-based standardized training system for multi-person online cooperative trauma emergency nursing of the present application. It can be seen from FIG. 1 that the VR-based standardized training system for multi-person online cooperative trauma emergency nursing provided by the present application mainly involves in three aspects, i.e., a teacher-side processing device, a management-side server device and student-side VR devices.

A teacher side is used for providing a hosting environment for medical staff who host trainings for trauma emergency, allowing them to perform task configuration processing on a standardized training task for multi-person online cooperative trauma emergency nursing and complete initial configuration of a current training task.

Of course, during the processing of the training task, the teacher side can also continuously participate in the configuration of the current training task, and can adjust the configuration according to the actual situation and real-time needs.

The teacher-side processing device specifically includes terminal devices such as UE, for example, devices such as a smart phone, a tablet computer, a personal digital assistance (PDA), a notebook computer, an all-in-one computer, a desktop computer or a smart band, which can be used for carrying relevant applications related to the present application in the form of a client, and can also be used for loading relevant applications related to the present application through a browser application by employing Web services.

The management-side server device is used for configuring a VR environment of the standardized training task for multi-person online cooperative trauma emergency nursing for the student-side VR devices. As a core of creating the VR environment and leading a trauma emergency task, the management-side server device can be equipped with three-dimensional models related to various VR environments, such as instruments, environments, drugs and tasks (roles), can also store data of training programs, such as flows and scores, and can also store relevant user data of training students and lead teachers, such as permissions and training records.

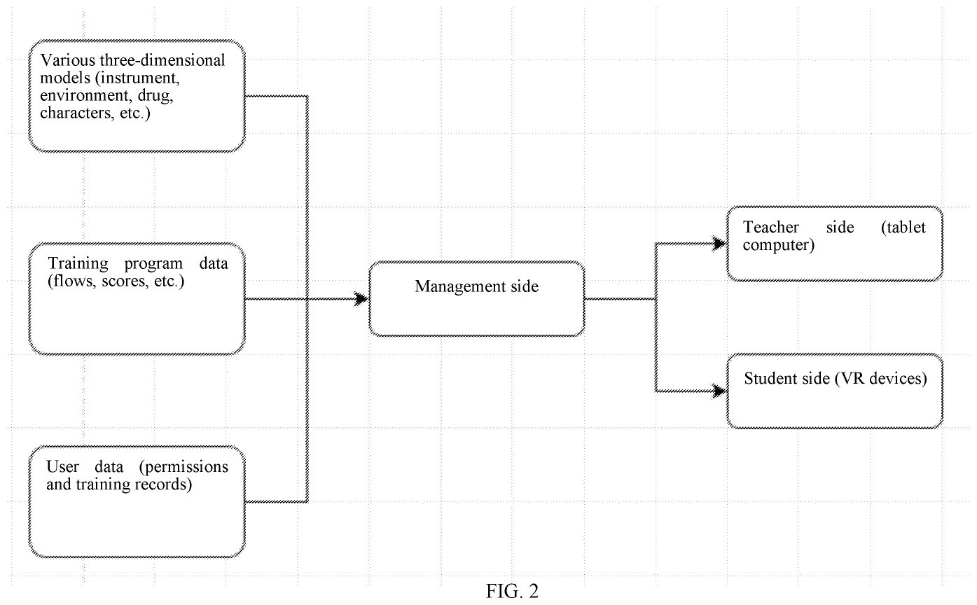

Specifically, as an example, reference may be further made to an example schematic diagram of the VR-based standardized training system for multi-person online cooperative trauma emergency nursing of the present application shown in FIG. 2 to facilitate more vivid understanding.

It can be seen from FIG. 1 and FIG. 2 that a remote management side performs complicated and key data processing work, and can also be used as a data transfer station between the teacher side and a student side, so that a relatively flexible training effect of trauma emergency nursing can be realized in terms of time and space.

It is easy to understand that, the performance of the management-side server device in the aspects of representation and human-computer interaction is significantly improved due to a training scenario for trauma emergency nursing, which is created by introducing a VR technology, and therefore, the device can be conveniently updated and maintained according to pre-designed flexible training requirements.

The student-side VR devices, also user-side devices, are different from the teacher-side processing device in that they can present corresponding VR images through the VR technology, and can collect relevant data of a wearer through relevant sensors configured, so as to realize the human-computer interaction in VR application scenarios.

The VR devices specifically can be specific VR device products, such as VR glasses and VR headsets. It should be understood that the specific form of the VR devices can be flexibly configured, the VR devices are usually used in conjunction with the VR technology, and the VR device products in the market can be directly employed, so they are not described in detail here in the present application.

Moreover, in a specific training scenario of trauma emergency, a training student can conduct multi-person online cooperation with other students in a multi-person online scenario displayed on a VR image through the VR device, and can be efficiently trained according to task content of a training task for trauma emergency in a case that the sense of participation and the sense of engagement are significantly improved.

For the above system architecture, in specific applications, a hybrid architecture of a browser/server (B/S) architecture and a client/server (C/S) architecture can be employed to form three terminal forms including the teacher side, the management side and the student side, realize a comprehensive system integrating editing, management, assessment and communication with the standardization of trauma emergency nursing as the core, and form a digital system with abundant content, strong interactivity, ease of operation, capability of being accessed anytime and anywhere and compliance with learning rules.

Moreover, under the above infrastructure content, its working process mainly includes the following content:

1) the teacher-side processing device is used for performing task configuration processing on a standardized training task for multi-person online cooperative trauma emergency nursing, where configuration content of the task configuration processing includes: creating a training, configuring trainers and a training program, pairing devices, checking a training progress, providing a view from a trainer perspective, and controlling the training; and
it can be understood that, for each training for trauma emergency, preliminary configuration is usually completed by the teacher side through the task configuration processing, and of course, real-time configuration during the training process may also be involved.

In addition, it should be understood that training content stored previously can also be directly called if previous and historical content of the trainings for trauma emergency is followed. Therefore, the description here can also be based on the overall perspective of a number of trainings for trauma emergency, rather than only involving a single or current training for trauma emergency.

2) The management-side server device is used for configuring the VR environment of the standardized training task for multi-person online cooperative trauma emergency nursing for the student-side VR devices according to the configuration content of the task configuration processing performed by the teacher-side processing device; and
it can be understood that after the teacher-side processing device completes a task configuration processing of the current training for trauma emergency, the management side can distribute corresponding tasks and build a VR environment for the student side/teacher side based on the configuration content of the task configuration processing, so that the currently involved training for trauma emergency can be officially conducted.

3) The student-side VR devices are used for downloading VR resources from the management-side server device according to the configuration content of the task configuration processing, and starting a standardized training for multi-person online cooperative trauma emergency nursing after a scenario is initialized and a training scenario is introduced, where the VR resources include scenarios, props, roles and tasks.

The student sides can be considered as a multi-person networking system. Each student side can simulate a role assigned by a current training task, for example, the system role can be configured with 5 types, i.e., LABCD, for selection; and multiple students can synchronize all operations, device locations, device states, patient states and treatment results and the like in the same scenario.

For the student sides, when the currently involved training for trauma emergency is conducted, it can involve in the downloading of required VR resources from the management side, so as to locally load the training scenarios required by the training; after the environment/scenario is normal, multi-person online cooperation can be performed with other students online based on the VR environment under the guidance of the teacher side; and under the condition of significantly improving the sense of participation and the sense of engagement, efficient trainings can be carried out according to the task content of the training task for trauma emergency.

It can be seen from the embodiment of FIG. 1 that, for the training for trauma emergency, the present application introduces the VR technology to establish the VR-based standardized training system for multi-person online cooperative trauma emergency nursing; the teacher-side processing device performs the task configuration processing on the standardized training task for multi-person online cooperative trauma emergency nursing, the management-side server device configures the VR environment of the standardized training task for multi-person online cooperative trauma emergency nursing for the student-side VR devices according to the configuration content of the task configuration processing performed by the teacher-side processing device; the student-side VR devices download the VR resources from the management-side server device according to the configuration content of the task configuration processing, and start the standardized training for multi-person online cooperative trauma emergency nursing after the scenario is initialized and a training scenario is introduced; in this system architecture, the device of each side is configured based on the VR technology to form a complete application scenario, so as to provide the medical staff with an efficient and conveniently-updated and maintained standardized training environment for multi-person online cooperative trauma emergency nursing, which can significantly improve the training effect of trauma emergency nursing of the medical staff.

A more specific description of the VR-based standardized training system for multi-person online cooperative trauma emergency nursing provided by the present application is given below in detail.

As an exemplary implementation, on the student side, a plurality of the student-side VR devices can also constitute a small local area network environment through an ad hoc network, and carry out data synchronization and transmission in the VR environment to realize real-time network synchronization of multi-person operation.

It can be understood that the setting here can utilize the local area network to perform a training for real-time communication during emergency, so as to realize the real-time synchronization of multi-user operations and ensure that multiple users can see positions, actions and operations of each other in the same virtual scenario clearly and in real time. Compared with using management-side server device as a relay, the improvement of data transmission speed can improve the fluency of images, so as to facilitate real-time interaction between the multiple users and further improve the training effect.

Further, for the network synchronization involved here, as yet another exemplary implementation, in practical application, at least one of state synchronization, real-time broadcast synchronization and frame synchronization (the three methods are not mutually exclusive, and can be used alone or together) can be specifically employed as the network synchronization, and furthermore, the network synchronization can also aim at simulating behaviors of other students with less amount of information synchronized, so that a network synchronization solution achieving the best effect is adapted in the process of continuous testing and actual use.

In general, the goal of the network synchronization is to simulate all actions of other users more realistically with less amount of information synchronized in a multi-person online state, so that the users can clearly know and see the positions, actions and states of other users in the training process/VR scenario as soon as possible.

In this case, in the specific research and development work, the present application has designed two launched supporting solutions, namely, the state synchronization and the real-time broadcast synchronization, the contents of which are as follows:

### I. State Synchronization

As yet another exemplary implementation, the state synchronization employed in the network synchronization of the present application can specifically include the following processing content:
when a current user gives a behavior control instruction through the student-side VR device, extracting data required by a behavior state in the behavior control instruction; and
broadcasting the data required by the behavior state to other student-side VR devices to facilitate simulation of behaviors of a corresponding role through the data required by the behavior state.

It can be understood that, it is believed in the present application that each state of a user's role in the VR environment is equivalent to a behavior pattern with fixed logic, and this fixed behavior pattern is like a black box. The same behavior can be shown as long as the required data is provided, for example, if a turning-over state is shown, a turning-over animation will be played.

These behavior states all have a common feature, that is, the individual effect of the same image can be shown as long as the required identical data is provided. Therefore, the present application aims at cohering and piecing these states into a role with a series of actions. When the student sends various instructions to his/her role, the role is told to trigger this state first and then that state. Because the instructions contain the data required by the behavior state, these data can be broadcast to each user who needs to see it, and the VR devices that receive these data can simulate the behaviors of their roles through these data, so as to make the VR image look like that many users are manipulating their own roles, achieving a concise and efficient synchronization effect.

### II. Real-Time Broadcast Synchronization

As yet another exemplary implementation, the real-time broadcast synchronization employed in the network synchronization of the present application can specifically include the following processing content:
sending, by a student-side VR device in use, position and rotation information of a student role to other student-side VR devices in a form of broadcasting; predicting, by the other student-side VR devices, current position, speed and acceleration of the student role of the student-side VR device in use according to received position and rotation information, and then predicting, by the other student-side VR devices, a rotation speed and a rotational acceleration to simulate the student role of the student-side VR device in use.

It can be understood that, it is believed in the present application that the movement speed and the rotation speed of the user in the VR environment are constantly changing, and the change frequency is relatively high. If the simulation for positions and rotation angles of different users in the VR scenario is required, these data need to be updated in real time. However, the above state synchronization solution is difficult to meet the demand of updating this part of data. Because the movement speed and rotation of the users change too fast and too frequently, it is difficult to split the synchronization state to simulate.

Here, the real-time broadcast synchronization solution mainly has the following features: position and rotation information is determined by the VR device (client); the VR device (client) sends the position and rotation information of its own user to other VR devices (other users) in the form of broadcasting; and after the other VR devices (other users) receive the position and rotation information, they predict current position, speed, acceleration, rotation speed and rotational acceleration of the user corresponding to data based on received position and rotation information, and perform simulation and displaying.

For example, each VR device (client) will send own position and rotation information to other VR devices (other users) for about 60 to 120 times within 1 second, so that the other users can more smoothly simulate the performance of movement and rotation of the user in the VR environment when receiving broadcast data, and only in this way can the other VR devices (clients) constantly update the position, movement speed and rotation angle of the user.

However, it is believed in the present application that if only position and rotation data are updated, the users in the VR image will keep flashing, so the present application uses speeds to represent their movement modes, which makes the simulated movement smoother. When receiving the broadcast real-time data of the users, first of all, the speeds are calculated and the speeds and acceleration are predicated, so that the simulated users can move in the screen in the form of speed and acceleration, rather than only updating the position, which significantly improves the fluency of the corresponding roles when simulating their walking position and direction in the screen.

In addition, for spatial localization of a corresponding role of the student-side VR device in the VR environment, in particular applications, the present application can specifically employ the inside-out localization technology, the surrounding environment is actively scanned through a plurality of cameras on the device, and an SLAM technology is used for locating the role while creating a map.

In particular, spatial localization processing is mainly used for implementing the spatial localization of roles in the VR scenario and serving to realize more human-computer interactions. It is mainly divided into two types such as outside-in and inside-out in terms of implementation; the former requires a plurality of externally placed pointing devices, and the devices emit infrared rays and the like to determine the position and movement direction of a wearer through a Triangulation localization method; and the latter uses the devices themselves instead of external accessories such as sensors to realize the spatial localization in the virtual scenarios and more human-computer interactions. In terms of the application effect, the former is more accurate, but it is inconvenient to place the pointing devices, while the latter is more convenient.

Taking the VR glasses as an example, the inside-out localization technology employed in the present application uses a plurality of cameras on the VR glasses to actively scan a surrounding environment, and uses the SLAM technology to simultaneously realize the localization while creating a map.

In addition, on the server side, i.e, the management-side server device, the present application can also perform more detailed related optimization configuration. Specifically, as yet another exemplary implementation, including that:
1. the management-side server device completes a multi-person task through automatic hosting of an AI service in a case that any trainer is offline or does not participate in the training during the task, so that the completion of the whole task can be ensured based on the overall training level;
2. the management-side server device enables multiple trainers to keep own task lines by utilizing a multi-thread and multi-task-line technology, where a degree of freedom of an individual task is higher than that of the multi-person task, so as to take the training requirements of both individual users and user groups into account, and help individuals to make early preparations before the next task, such as fetching a caliper splint before the caliper splint is placed through the assistance of multiple persons.
3. the management-side server device utilizes a structured database to construct a drug library, an instrument library, a consumable library, a report library, a patient library, a scenario library, a student library, a device library, a traumatic condition library and a treatment library, and randomly collocates different cases in a background management system to automatically form a massive case library system, so that the richness of the scenarios and the training efficiency can be significantly improved; and
4. the management-side server device utilizes a hot update technology to facilitate dynamic on-demand loading of scripts, models and resources, so as to update the resources and reduce the configuration requirements of the device.

For a hot update mechanism involved here, hot update may include two aspects: the update of resources and the update of scripts. Taking Unity3d as an example, a solution for providing hot update of Unity3d is AssetsBundle (hereinafter referred to as AB), which is similar to a compressed file. Related resources and codes can be packed into AB packages and loaded to a server, and then compared with MD5 version for hot update. It can minimize the memory pressure at runtime by distributing the resources in different AB packages, and can selectively load contents, such as models, maps, prefabricated parts, sound effects and material balls.

In addition, for user experience on the student side, the present application can also optimize the design of details in terms of human-computer interaction that the student can directly perceive. Specifically, as yet another exemplary implementation, the student-side VR device can realize voice conversation among roles by using a TTS system, for example, to realize voice conversation among roles such as patients, doctors and nurses, rather than a simple text prompt form, so as to not only facilitate the human-computer interaction of the students, but also realize a better sense of engagement in the VR environment, thus promoting the training effect of trainings for trauma emergency.

The above is the introduction of the VR-based standardized training system for multi-person online cooperative trauma emergency nursing provided by the present application, and on the basis of the VR-based standardized training system for multi-person online cooperative trauma emergency nursing, the present application also provides a processing method of the VR-based standardized training system for multi-person online cooperative trauma emergency nursing from the perspective of a control method.

It can be understood that, the method is applied to the VR-based standardized training system for multi-person online cooperative trauma emergency nursing. The system mainly includes a teacher-side processing device, a management-side server device and student-side VR devices. Correspondingly, the method can specifically include the following steps:

performing, by the teacher-side processing device, task configuration processing on a standardized training task for multi-person online cooperative trauma emergency nursing, where configuration content of the task configuration processing includes: creating a training, configuring trainers and a training program, pairing devices, checking a training progress, providing a view from a trainer perspective, and controlling the training;
configuring, by the management-side server device, a VR environment of the standardized training task for multi-person online cooperative trauma emergency nursing for student-side VR devices according to the configuration content of the task configuration processing performed by the teacher-side processing device; and
downloading, by the student-side VR devices, VR resources from the management-side server device according to the configuration content of the task configuration processing, and starting a standardized training for multi-person online cooperative trauma emergency nursing after a scenario is initialized and a training scenario is introduced, where the VR resources include scenarios, props, roles and tasks.

In an exemplary implementation, a plurality of student-side VR devices constitute a small local area network environment through an ad hoc network, and carry out data synchronization and transmission in the VR environment to realize real-time network synchronization of multi-person operation.

In yet another exemplary implementation, at least one of state synchronization, real-time broadcast synchronization and frame synchronization is specifically employed as the network synchronization, and the network synchronization aims at simulating behaviors of other students with less amount of information synchronized.

In yet another exemplary implementation, the state synchronization includes the following processing content:
when a current user gives a behavior control instruction through the student-side VR device, extracting data required by a behavior state in the behavior control instruction; and
broadcasting the data required by the behavior state to other student-side VR devices to facilitate simulation of behaviors of a corresponding role through the data required by the behavior state.

In yet another exemplary implementation, the real-time broadcast synchronization includes the following processing content:
sending, by a student-side VR device in use, position and rotation information of a student role to other student-side VR devices in a form of broadcasting; predicting, by the other student-side VR devices, current position, speed and acceleration of the student role of the student-side VR device in use according to received position and rotation information, and then predicting, by the other student-side VR devices, a rotation speed and a rotational acceleration to simulate the student role of the student-side VR device in use.

In yet another exemplary implementation, spatial localization of a corresponding role of the student-side VR device in the VR environment employs the inside-out localization technology, the surrounding environment is actively scanned through a plurality of cameras on the device, and the SLAM technology is used for locating the role while creating a map.

In yet another exemplary implementation, the management-side server device completes a multi-person task through automatic hosting of an AI service in a case that any trainer is offline or does not participate in the training during the task;
the management-side server device enables multiple trainers to keep own task lines by utilizing a multi-thread and multi-task-line technology, where a degree of freedom of an individual task is higher than that of the multi-person task;
the management-side server device utilizes a structured database to construct a drug library, an instrument library, a consumable library, a report library, a patient library, a scenario library, a student library, a device library, a traumatic condition library and a treatment library, and randomly collocates different cases in a background management system to automatically form a massive case library system; and
the management-side server device utilizes a hot update technology to facilitate dynamic on-demand loading of scripts, models and resources.

In yet another exemplary implementation, the student-side VR device realizes voice conversation among roles by using the TTS system.

Those skilled in the art can clearly understand that, for convenience and brevity of description, reference can be made to the description of the VR-based standardized training system for multi-person online cooperative trauma emergency nursing in the corresponding embodiment shown in FIG. 1 for specific working processes of the processing method of the VR-based standardized training system for multi-person online cooperative trauma emergency nursing. Details are not described herein again.

Those skilled in the art can understand that all or part of steps in various methods of the above embodiments can be completed by instructions or by controlling related hardware through the instructions, which can be stored in a computer-readable storage medium and loaded and executed by a processor.

To this end, the present application provides a computer-readable storage medium, where a plurality of instructions are stored, which can be loaded by a processor to execute the steps of the processing method of the VR-based standardized training system for multi-person online cooperative trauma emergency nursing in the above corresponding embodiments of the present application. For specific operations, reference can be made to the description of the processing method of the VR-based standardized training system for multi-person online cooperative trauma emergency nursing in the above corresponding embodiments. Details are not described herein again.

The computer-readable storage medium may include: a read only memory (ROM), a random access memory (RAM), a magnetic disk or an optical disk and the like.

Due to the instructions stored in the computer-readable storage medium, the steps of the processing method of the VR-based standardized training system for multi-person online cooperative trauma emergency nursing in the above corresponding embodiments of the present application can be executed. Therefore, the beneficial effects that can be achieved by the processing method of the VR-based standardized training system for multi-person online cooperative trauma emergency nursing in the above corresponding embodiments of the present application can be achieved. See the previous description for details, and details are not described herein again.

The above describes the VR-based standardized training system for multi-person online cooperative trauma emergency nursing, the processing method of the VR-based standardized training system for multi-person online cooperative trauma emergency nursing, and the computer-readable storage medium provided by the present application in details. Specific embodiments are used herein for elaborating the principle and implementations of the present application. The description of the foregoing embodiments is merely intended to help understand the core idea of the present application. In addition, those skilled in the art can make variations to specific implementations and application scopes based on the idea of the present application. In conclusion, the content of this specification should not be construed as a limitation to the present application.

1. A virtual reality (VR) based standardized training system for multi-person online cooperative trauma emergency nursing, wherein the system comprises:
a teacher-side terminal device, which is used for performing task configuration processing on a standardized training task for multi-person online cooperative trauma emergency nursing, wherein configuration content of the task configuration processing comprises: creating a training, configuring a training program, pairing devices, checking a training progress, providing a view from a student perspective, and controlling the training;
a management-side server device, which is used for configuring a VR environment of the standardized training task for multi-person online cooperative trauma emergency nursing for student-side VR devices according to the configuration content of the task configuration processing performed by the teacher-side terminal device;
the student-side VR devices, which are used for downloading VR resources from the management-side server device according to the configuration content of the task configuration processing, and starting a standardized training for multi-person online cooperative trauma emergency nursing after a scenario is initialized and a training scenario is introduced, wherein the VR resources comprise scenarios, props, roles, and tasks;
a plurality of the student-side VR devices constitute a small local area network environment through an ad-hoc network, and carry out data synchronization and transmission in the VR environment to realize real-time network synchronization of multi-person operation;
real-time broadcast synchronization is specifically employed as the network synchronization;
the real-time broadcast synchronization comprises the following processing content:
sending, by a first student-side VR device of the student-side VR devices, position and rotation information of a student role to other student-side VR devices in a form of broadcasting at a frequency of 60 to 120 times per second; predicting, by the other student-side VR devices, current position, speed and acceleration of the student role of the first student-side VR device according to the position and rotation information and received at the frequency, and then predicting, by the other student-side VR devices, a rotation speed and a rotational acceleration to simulate the student role of the first student-side VR device.

2. The system according to claim 1, wherein spatial localization of the first student-side VR device in the VR environment employs an inside-out localization technology, a surrounding environment is actively scanned through a plurality of cameras on the first student-side VR device, and a simultaneous localization and mapping (SLAM) technology is used for locating the spatial localization while creating a map.

3. The system according to claim 1, wherein the management-side server device completes a multi-person task through automatic hosting of an artificial intelligence (AI) service in a case that any student is offline or does not participate in the multi-person task;
the management-side server device enables multiple students to keep own task lines, wherein a degree of freedom of an individual task is higher than that of the multi-person task;
the management-side server device utilizes a structured database to construct a drug library, an instrument library, a consumable library, a report library, a patient library, a scenario library, a student library, a device library, a traumatic condition library and a treatment library, and collocates different cases in a background management system to automatically form a case library system; and
the management-side server device utilizes a hot update technology to facilitate dynamic on-demand loading of scripts, models and resources.

4. The system according to claim 1, wherein the student-side VR devices realize voice conversation among roles by using a text to speech (TTS) system.

5. A processing method of a virtual reality (VR) based standardized training system for multi-person online cooperative trauma emergency nursing, wherein the method comprises:
performing, by a teacher-side terminal device, task configuration processing on a standardized training task for multi-person online cooperative trauma emergency nursing, wherein configuration content of the task configuration processing comprises: creating a training, configuring a training program, pairing devices, checking a training progress, providing a view from a student perspective, and controlling the training;
configuring, by a management-side server device, a VR environment of the standardized training task for multi-person online cooperative trauma emergency nursing for student-side VR devices according to the configuration content of the task configuration processing performed by the teacher-side terminal device;
downloading, by the student-side VR devices, VR resources from the management-side server device according to the configuration content of the task configuration processing, and starting a standardized training for multi-person online cooperative trauma emergency nursing after a scenario is initialized and a training scenario is introduced, wherein the VR resources comprise scenarios, props, roles and tasks;
a plurality of the student-side VR devices constitute a small local area network environment through an ad-hoc network, and carry out data synchronization and transmission in the VR environment to realize real-time network synchronization of multi-person operation;
real-time broadcast synchronization is specifically employed as the network synchronization;
the real-time broadcast synchronization comprises the following processing content:
sending, by a first student-side VR device of the student-side VR devices, position and rotation information of a student role to other student-side VR devices in a form of broadcasting at a frequency of 60 to 120 times per second; predicting by the other student-side VR devices, current position, speed and acceleration of the student role of the first student-side VR device according to the position and rotation information received at the frequency, and then predicting, by the other student-side VR devices, a rotation speed and a rotational acceleration to simulate the student role of the first student-side VR device.

6. A non-transitory computer-readable storage medium, wherein the computer-readable storage medium stores a plurality of instructions, and the instructions are suitable for being loaded by a processor to execute the method according to claim 5.
